(19) United States
(12) Patent Application Publication
(10) Pub. No.: US 2010/0286895 A1
(43) Pub. Date: Nov. 11, 2010

(54) METHOD FOR MONITORING AT LEAST ONE GLOW PLUG OF AN INTERNAL COMBUSTION ENGINE AND CORRESPONDING DEVICE

(76) Inventors: Hans-Peter Bauer, Ditzingen (DE); Rainer Moritz, Filderstadt (DE); Simon Schmittinger, Renningen (DE); Andreas Reissner, Stuttgart (DE)

Correspondence Address: KENYON & KENYON LLP, ONE BROADWAY, NEW YORK, NY, 10004, US

(21) Appl. No.: 12/811,507

(22) PCT Filed: Nov. 14, 2008
(86) PCT No.: PCT/EP2008/065550

§ 371 Date: Jul. 1, 2010

(30) Foreign Application Priority Data
Feb. 4, 2008 (DE) 10 2008 007 397.0

(51) Int. Cl. F02D 41/22; F02P 19/02

(52) U.S. Cl. 701/113; 73/114.62

(57) ABSTRACT

A method for monitoring at least one glow plug of an internal combustion engine in which a time-dependent variable, which characterizes the current flowing through the at least one glow plug, is compared for fault recognition to at least one time-dependent minimum and/or maximum threshold value, and a fault is recognized if the time-dependent variable is greater and/or less than the minimum and/or maximum threshold value. The method is characterized in that the first derivative of the time-dependent variable is compared to the first derivative of the maximum threshold value and the second derivative of the time-dependent variable is compared to the second derivative of the maximum threshold value, and a fault is recognized if the first derivative of the time-dependent variable is less than the first derivative the maximum threshold value, and the second derivative of the time-dependent variable is less than the second derivative of the maximum threshold value.

### FIELD OF THE INVENTION

The present invention relates to a method for monitoring at least one glow plug of an internal combustion engine, and a corresponding device.

### BACKGROUND INFORMATION

Glow plugs are typically monitored in internal combustion engines in that the current flowing through the glow plugs is compared to a predefined fixed threshold value. If the power consumption by the glow plug is less than the threshold value, the glow plug is evaluated as faulty. Similar circuits use comparators or differential amplifiers for this purpose. Microcomputer-based glow time control units ascertain a digital value corresponding to the current through the glow plug via an analog/digital converter and compare this value to a stored digital threshold value.

It is problematic that the current flow of the glow plug after application of the supply voltage is strongly time-dependent. The monitoring of the glow plug on the basis of a fixed current value therefore only allows a very coarse evaluation.

FIG. 5 shows a graph of a current flow of a current I_{plug} through a glow plug in relation to time for monitoring at least one glow plug, as is used in the related art for ascertaining a faulty glow plug. The current flow drops with increasing defectiveness of the glow plug with time. A lower threshold value IU is used, which is determined on the basis of a model of the glow plug or is taken from a computer model. This lower threshold value IU is a threshold for error recognition. Conventionally, if the current flow falls below this lower threshold value IU, a fault of the glow plug is recognized, upon which the glow plug circuit is interrupted to prevent fusing of the glow plug or of the heater in the case of metal cores. Fusing of the glow plug may result in total engine damage. In addition to the lower threshold value IU, an upper threshold value may also be determined, a fault of the glow plug being recognized if the current flow exceeds this upper threshold value.

It has proven to be disadvantageous that the current flow varies erratically with increasing reduction of the current value. It is shown in the figure that below a current value IB, the current flow is at least strongly wavy and has a discontinuity at a point in time t1. This current value IB is still above lower threshold value IU. In the time range of the current flow up to t1, above current value IB, a possible flow of the current is conventionally recognized. More precisely, the current flow may be predicted or modeled in this range. In the time range of the current flow from t1, below current value IB, in contrast, the possible flow may not be exactly inferred. This is disadvantageous because in this range, a drop below lower threshold value IU is hardly or not at all recognizable, or at least only with a delay. Fault recognition of the glow plug is thus unreliable, with the possible risk of fusing of the glow plug and total engine damage.

### SUMMARY

It is an object of the present invention to provide a method which allows reliable monitoring of at least one glow plug of an internal combustion engine. It is a further object of the present invention to provide a corresponding device.

This object may be achieved by an example method for monitoring at least one glow plug of an internal combustion engine, in which a time-dependent variable, which characterizes the current flowing through the at least one glow plug, is compared for fault recognition to at least one time-dependent minimum and/or maximum threshold value, and a fault is recognized if the time-dependent variable is greater and/or less than the minimum and/or maximum threshold variable. The example method is characterized in that the first derivative of the time-dependent variable is compared to the first derivative of the maximum threshold value and the second derivative of the time-dependent variable is compared to the second derivative of the maximum threshold value, and a fault is recognized if the first derivative of the time-dependent variable is less than the first derivative of the maximum threshold value and the second derivative of the time-dependent variable is less than the second derivative of the maximum threshold value.

In accordance with the example method of the present invention, a fault of the glow plug is reliably recognized.

It is therefore provided in an advantageous specific embodiment of the present invention that the time-dependent variable, which characterizes the current flowing through the at least one glow plug, is a resistance model of the glow plug. The circuitry complexity or the programming complexity in the control unit may thus be significantly reduced and a simple and cost-effective achievement of the object is available.

The time-dependent threshold value preferably contains the characteristic curve of the resistance of the corresponding glow plug. The circuitry complexity or the programming complexity in the control unit may also be significantly reduced here and a simple and cost-effective achievement of the object is available.

A glow plug circuit is preferably turned off in the event of fault recognition. Fusing of the glow plug, in particular of the heater in the case of metal cores, may thus be prevented.

Corresponding information is preferably entered in a fault memory in the event of fault recognition. An effective glow plug control may thus be ensured.

A diagnostic message is preferably transmitted in the event of fault recognition. An effective glow plug control may thus also be ensured.

A glow plug control is preferably changed in response to the diagnostic message. The glow plug control may thus always be updated to new parameters.

A notification about the status of the glow plug is preferably displayed to the driver in response to the diagnostic message. The driver is thus always informed about the status of the glow plug and may optionally adjust his driving behavior thereto.

In a preferred specific embodiment, a device for monitoring at least one glow plug of an internal combustion engine contains an evaluation unit, which contains a comparator arrangement, which compares a time-dependent variable, which characterizes the current flowing through the at least one glow plug, for error recognition to at least one time-dependent minimum and/or maximum threshold value, and the evaluation unit recognizes a fault if the time-dependent variable is greater and/or less than the minimum and/or maximum threshold value. The device is characterized in that the evaluation unit also contains a further comparison means, which compares the first derivative of the time-dependent variable to the first derivative of the maximum threshold value and the second derivative of the time-dependent variable to the second derivative of the maximum threshold value, and the evaluation unit recognizes a fault if the first derivative of the time-dependent variable is less than the first derivative of the maximum threshold value and the second derivative of the time-dependent variable is less than the second derivative of the maximum threshold value. The complexity in the application of the control unit may thus be significantly reduced.

The comparator arrangement preferably contain at least one comparator.

An example method according to the present invention and the corresponding device are explained in greater detail hereafter on the basis of exemplary embodiments. Identical or identically-functioning parts are provided with identical reference numerals.

### BRIEF DESCRIPTION OF THE DRAWINGS

FIG. 1 shows a specific embodiment of a conventional device for monitoring at least one glow plug.

FIG. 2 shows an illustration of a simulation of a conventional glow plug.

FIG. 3 shows a specific example embodiment according to the present invention of a device for monitoring at least one glow plug.

FIG. 4 shows a current flow through a glow plug in relation to time for monitoring at least one glow plug in a specific example embodiment of the present invention.

FIG. 5 shows a current flow through a glow plug in relation to time for monitoring at least one glow plug.

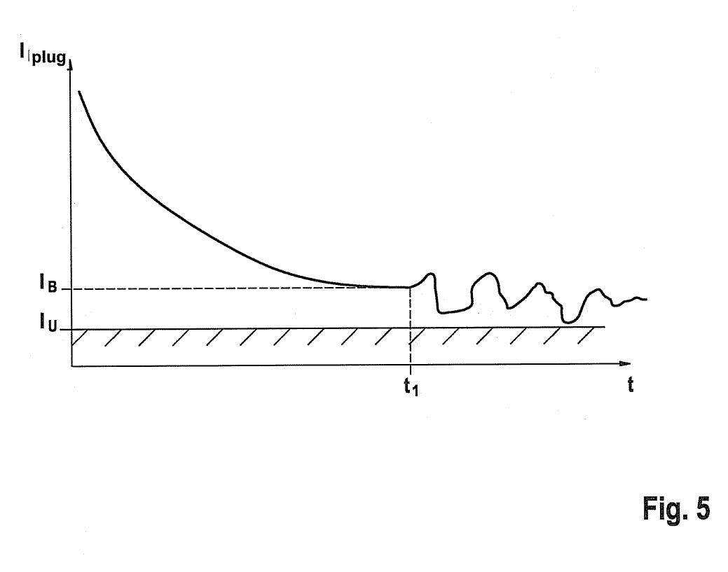

### DETAILED DESCRIPTION OF EXAMPLE EMBODIMENTS

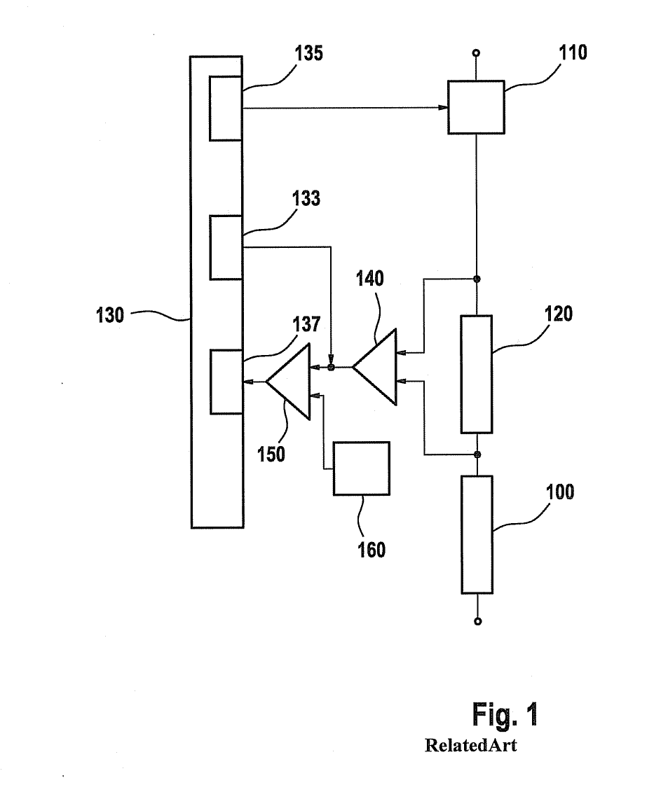

FIG. 1 shows a specific embodiment of a conventional device for monitoring at least one glow plug, as described, for example, in German Patent Application No. DE 10 2006 005 711 A. A glow plug 100 is connected in series to an ammeter 120 and a switch 110 between the two terminals of a supply voltage. In the exemplary embodiment shown, one ammeter 120 and one switch 110 are provided for each glow plug. In one embodiment of the device according to the present invention, a common switch 110 and/or a common ammeter 120 may also be provided for multiple glow plugs or all glow plugs of an internal combustion engine. The illustrated specific embodiment, in which one ammeter 120 and one switch 110 are associated with each glow plug, offers the advantage that the glow plugs may be individually activated and the current flowing through the particular glow plug may be analyzed. If multiple glow plugs are combined into a group, or if all glow plugs are activated jointly and/or the current is analyzed jointly, this offers the advantage that more expensive elements, such as the switching means, may be saved and a significant cost savings thus results.

Furthermore, a control unit 130 is provided, which includes an analyzer unit 133, an activation unit 135, and an error recognition unit 137, in addition to further elements (not shown). Activation unit 135 activates switch 110, to supply a desired energy to the glow plug. Analyzer unit 133 analyzes the voltage drop across ammeter 120, in order to ascertain the current which flows through the glow plug. Ammeter 120 is preferably implemented as an ohmic resistor. The voltage drop across ammeter 120 is supplied to an amplifier 140, which provides its output signal to analyzer unit 133. Furthermore, the output signal of measuring amplifier 140 reaches a comparator 150, to whose second input the output signal of a threshold value setpoint 160 is applied.

The glow plugs typically have a very low resistance at the beginning of energization. This has the result that a very large current flows at the beginning of energization. The resistance of the glow plug increases through their heating, which in turn has the result that the current drops. It has been shown to be disadvantageous that the current flow varies very erratically with increasing reduction of the current value.

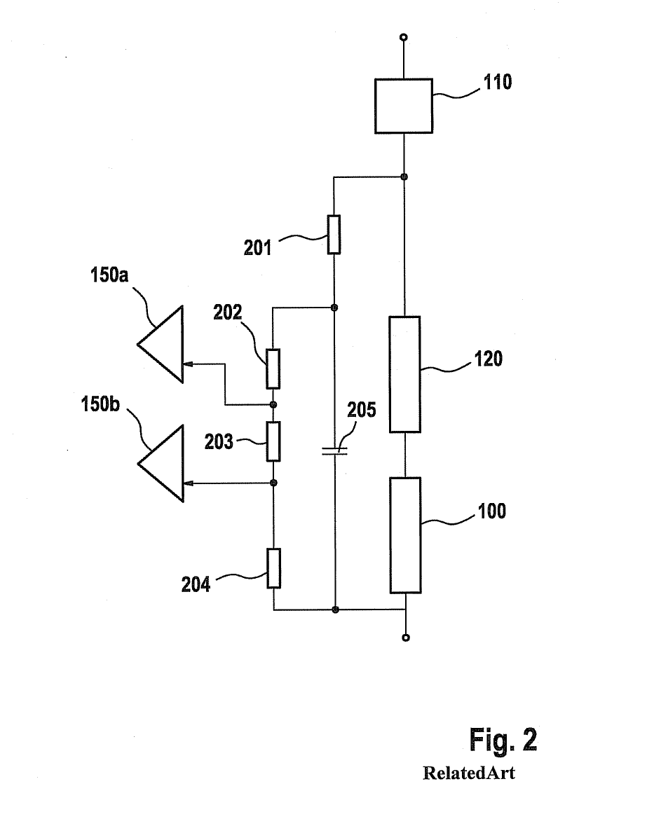

FIG. 2 shows an illustration of a simulation of a conventional glow plug, as described, for example, in German Patent Application No. DE 10 2006 005 711 A. Essential elements of FIG. 1, in particular threshold value setpoint 160, are shown in greater detail in the figure. Threshold value setpoint 160 is generally formed in this specific embodiment by an RC circuit. This circuit is made up of a series circuit of a resistor 201 and a capacitor 205, which are situated between the ground terminal and the connection point between ammeter 120 and switch 110. This means that a voltage which is generally proportional to the voltage drop across glow plug 100 is applied to capacitor 205. Furthermore, a series circuit is made up of resistor 201 and further resistors 202, 203, and 204. This series circuit is accordingly situated between the ground terminal and the connection point between switch 110 and ammeter 120. The input signal for a comparator 150a is tapped at the connection point between resistors 202 and 203. The signal for a second comparator 150b is tapped at the connection point between resistors 203 and 204. Both comparators 150a and 150b correspond to comparator 150 shown in FIG. 1.

In the specific embodiment, two comparators are provided, so that a threshold value query having a lower threshold value and an upper threshold value is possible. In a simplified specific embodiment, one of the two comparators and one of three resistors 202, 203, or 204 may be dispensed with. In this specific embodiment, only a comparison to a threshold value is possible. The same voltage which is applied to the glow plug to be monitored is applied to the voltage divider and the series circuit made up of capacitor 205 and resistor 201.

The voltage drop, which corresponds to the current which flows through the glow plug, is compared to the voltage drop across capacitor 205. The entire voltage is not analyzed for this purpose, but rather the voltage divided by the voltage divider, made up of resistors 202, 203, and 204. A signal is applied to each of the outputs of comparators 150a and 150b, which indicates a fault or indicates a faultless operation as a function of the comparison.

The circuit shown represents a simple simulation of the glow plug. The voltage at the capacitor is a function of the charge of the capacitor. The capacitor has an integrating effect and adds up the energy introduced into the glow plug. This is achieved in that a voltage proportional to the voltage drop across the glow plug is applied to capacitor 205. The charge state or the voltage at capacitor 205 is a measure of the temperature or the resistance of the glow plug. Through suitable selection of the values of the capacitor and the resistors, the behavior over time of the output voltage of the voltage divider, which is formed by resistors 202, 203, and 204, corresponds to the behavior over time of the faultless current through the glow plug. The lower and/or upper threshold values may be predefined by a corresponding allocation of the resistance values. It has been shown to be disadvantageous that the current flow behaves very erratically with increasing drop of the current value.

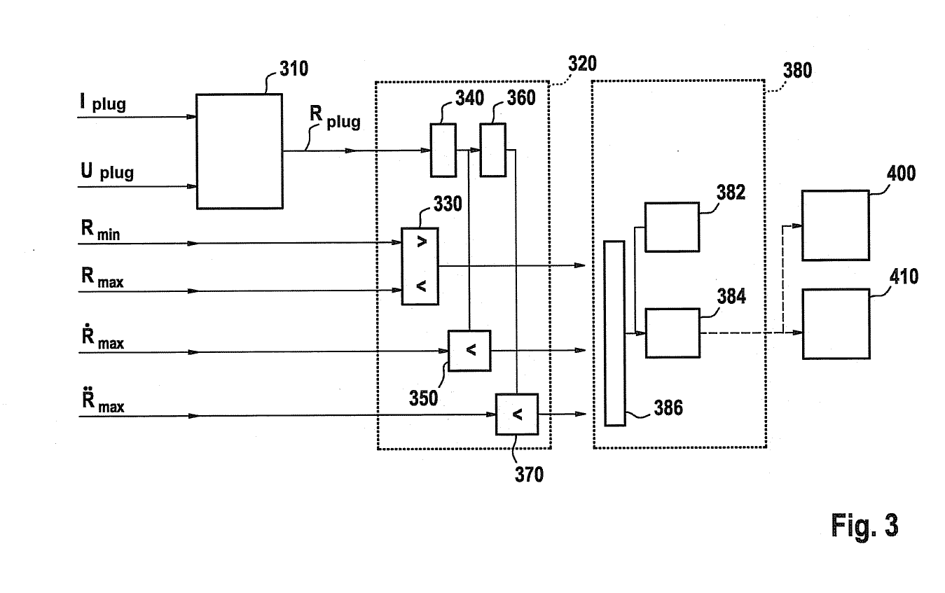

FIG. 3 shows a specific example embodiment of a device according to the present invention for monitoring at least one glow plug in a simplified circuit diagram. In this specific example embodiment according to the present invention, measured current flow I_{plug} from the glow plug and measured voltage U_{plug} applied via the glow plug are input into a computing unit 310, which calculates a measured resistance R_{plug}=U_{plug}/I_{plug} from the quotient of voltage U_{plug} and current I_{plug}. For this purpose, a ratiometric or voltage-compensated current measurement is performed.

Resistance value R_{plug} is input into an evaluation unit 320. In evaluation unit 320, resistance value R_{plug} is input directly into a first comparison unit 330, which contains two comparators, for example. A minimum resistance threshold value Rₘᵢₙ and a maximum resistance threshold value Rₘₐₓ of the glow plug are also input into first comparison unit 330. First comparison unit 330 compares resistance value R_{plug} to minimum resistance threshold value Rₘᵢₙ and maximum resistance threshold value Rₘₐₓ of the glow plug, as already described in the explanation of FIGS. 2 and 3.

Evaluation unit 320 also contains a first derivation unit 340, which calculates a first derivative over time d/dt, and which is also connected to the signal circuit for supplying resistance value R_{plug}. First derivation unit 340 performs a first time derivation on resistance value R_{plug} for this purpose and feeds the result to a second comparison unit 350. Second comparison unit 350 compares the result of the first derivative from first derivation unit 340 to a value of a first derivative of maximum resistance threshold value \dot{R}ₘₐₓ of the glow plug.

Evaluation unit 320 also contains a second derivation unit 360, which is connected to the output of first derivation unit 340. Second derivation unit 360 performs a derivation over time on the first derivative of resistance value R_{plug} and supplies the result, namely a second derivative of resistance value \ddot{R}_{plug}, to a third comparison unit 370. Third comparison unit 370 compares the result of the second derivative of resistance value R_{plug} from second derivation unit 360 to a value of a second derivative of maximum resistance threshold value \ddot{R}ₘₐₓ of the glow plug.

First comparison unit 330 of evaluation unit 320 is implemented in such a way that a signal is output which indicates a fault of the glow plug if resistance value R_{plug} is greater than minimum resistance threshold value Rₘᵢₙ, or resistance value R_{plug} is less than maximum resistance threshold value Rₘₐₓ. In contrast, second comparison unit 350 of evaluation unit 320 is implemented in such a way that a signal which indicates a fault of the glow plug is output if the first derivative over time of the resistance value of the glow plug is less than the first derivative of maximum resistance threshold value \dot{R}ₘₐₓ Furthermore, third comparison unit 370 of evaluation unit 320 is implemented in such a way that a signal which indicates a fault of the glow plug is output if the second derivative over time of the resistance value of the glow plug is less than the second derivative of maximum resistance threshold value \ddot{R}ₘₐₓ.

The output signals, which indicate a fault of the glow plug, are each input into a control unit 380, which turns off the glow plug circuit and/or enters appropriate information in a fault memory 382 and/or transmits a diagnostic message via a transmitter 384 in response to only a single input signal. Fault memory 382 and transmitter 384 may be connected for this purpose via an interface 386, which receives the input signals at control unit 380 and relays them to fault memory 382 and transmitter 384.

In response to the transmitted diagnostic message, a change in a glow plug control may optionally be caused in a glow plug unit 400, which is connected to transmitter 384. Furthermore, a notification about the status of the glow plug may be displayed to the driver via a display 410 in response to the transmitted diagnostic message.

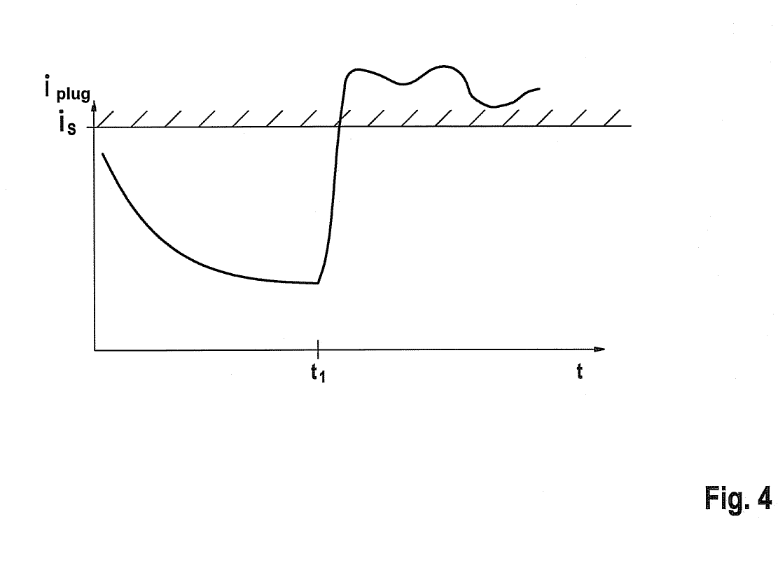

FIG. 4 shows a graph of a current flow of a first derivative İ_{plug} through a glow plug in a specific embodiment of the present invention. In this case, the current flow is used in one specific embodiment of the present invention to monitor at least one glow plug. The first derivative of current İ_{plug}. flowing through the glow plug is plotted against time t. A possible threshold value is plotted in the graph as İs, a faulty glow plug being recognized if current İ_{plug} flowing through the glow plug exceeds this threshold value İS. Up to a time t1, current İ_{plug} flowing through the glow plug runs below threshold value İS. At point in time t1, the curve of current İ_{plug} flowing through the glow plug experiences a sudden rise, as may be explained by a sudden defect of the glow plug. The rise is in such a way that threshold value İS is exceeded. A faulty glow plug is thus recognized rapidly and reliably. A defect of the glow plug may thus be recognized very rapidly and reliably in the engine control unit and possible engine damage may be avoided.

1-10. (canceled)

11. A method for monitoring at least one glow plug of an internal combustion engine, comprising:
comparing a first derivative of a time-dependent variable which characterizes current flow through the at least one glow plug to a first derivative of a maximum threshold value;
comparing a second derivative of the time-dependent variable to a second derivative of the maximum threshold value; and
recognizing a fault if the first derivative of the time-dependent variable is less than the first derivative of the maximum threshold value, and the second derivative of the time-dependent variable is less than the second derivative of the maximum threshold value.

12. The method for monitoring at least one glow plug of an internal combustion engine as recited in claim 11, wherein the time-dependent variable which characterizes the current flowing through the at least one glow plug is a resistance model of the glow plug.

13. The method for monitoring at least one glow plug of an internal combustion engine as recited in claim 11, wherein the time-dependent threshold value includes a characteristic curve over time of a resistance of the glow plug.

14. The method for monitoring at least one glow plug of an internal combustion engine as recited in claim 11, wherein a glow plug circuit is shut down in the event of fault recognition.

15. The method for monitoring at least one glow plug of an internal combustion engine as recited in claim 11, wherein information is entered in a fault memory in the event of fault recognition.

16. The method for monitoring at least one glow plug of an internal combustion engine as recited in claim 11, wherein a diagnostic message is transmitted in the event of fault recognition.

17. The method for monitoring at least one glow plug of an internal combustion engine as recited in claim 16, wherein a glow plug control is changed in response to the diagnostic message.

18. The method for monitoring at least one glow plug of an internal combustion engine as recited in claim 16, wherein a notification about a status of the glow plug is displayed to a driver in response to the diagnostic message.

19. A device for monitoring at least one glow plug of an internal combustion engine, comprising:
an evaluation unit including a comparison arrangement, the comparison arrangement to compare a time-dependent variable which characterizes current flowing through the at least one glow plug, for fault recognition to at least one of: i) at least one time-dependent minimum threshold value, and ii) at least one maximum threshold value, and the evaluation unit adapted to recognize a fault if the time-dependent variable is at least one of greater and less than at least one of the minimum and maximum threshold value;
wherein the evaluation unit includes a further comparison arrangement to compare a first derivative of the time-dependent variable to a first derivative of the maximum threshold value and to compare a second derivative of the time-dependent variable to a second derivative of the maximum threshold value, and wherein the evaluation unit is adapted to recognize a fault if the first derivative of the time-dependent variable is less than the first derivative of the maximum threshold value, and the second derivative of the time-dependent variable is less than the second derivative of the maximum threshold value.

20. The device for monitoring at least one glow plug of an internal combustion engine as recited in claim 19, wherein the comparator arrangement includes at least one comparator.
